(19) United States
(12) Patent Application Publication
(10) Pub. No.: US 2009/0123814 A1
(43) Pub. Date: May 14, 2009

(54) POWER SOURCE AND METHOD OF MANAGING A POWER SOURCE

(76) Inventors: Mason Cabot, San Francisco, CA (US); Forrest Deuth, Palo Alto, CA (US)

Correspondence Address: SCHOX PLC, 730 Florida Street #2, San Francisco, CA, 94110, US

(21) Appl. No.: 12/247,920

(22) Filed: Oct. 8, 2008

Related U.S. Application Data
(60) Provisional application No. 60/978,684, filed on Oct. 9, 2007.
(60) Provisional application No. 61/040,091, filed on Mar. 27, 2008.
(60) Provisional application No. 61/040,094, filed on Mar. 27, 2008.

(51) Int. Cl. H01M 6/00

(52) U.S. Cl. 429/50; 429/61; 429/62

(57) ABSTRACT

In one embodiment, the invention includes a power source having a plurality of battery groups and a processor coupled to the groups and adapted to electrically disconnect a group from the power source. Each group includes a plurality of cells, a sensor adapted to sense operating parameters of the cells, and a protection circuit coupled to the sensor. In another embodiment, the invention includes a method of managing a power source with a two-tier approach. On a group level, the method includes retrieving cell data representative of the operating parameters of the cells of the group and managing the connection state of the group based on the retrieved cell data. On a system level, the method includes, retrieving group data representative of the operating parameters of the groups and managing the connection state of the group based on the retrieved group data.

### CROSS-REFERENCE TO RELATED APPLICATIONS

This application claims the benefit of U.S. Provisional Application No. 60/978,684 filed 9 Oct. 1007; U.S. Provisional Application No. 60/978,685 filed 9 Oct. 2007; U.S. Provisional Application No. 61/040,091 filed 27 Mar. 2008; and U.S. Provisional Application No. 61/040,094 filed 27 Mar. 2008. All four provisional applications are incorporated in their entirety by this reference.

### TECHNICAL FIELD

This invention relates generally to the power source field, and more specifically to an improved power source and method of managing a power source.

### BACKGROUND

High-density battery packs have the energy density required for transportation applications but may fail catastrophically, unexpectedly, and fatally if poorly managed. Current battery packs provide either acceptable energy density (lithium ion or lithium polymer) or safety features (nickel metal hydride, lead acid), but not both. Existing solutions to this problem use traditional methods of protection and isolation. For example, some automotive battery packs use an assortment of mechanical, thermal, and electrical techniques to isolate faulty cell groups (e.g. thermal fuses and heavy packaging or physical firewalls). These techniques are typically used, however, with large groups of cells, so a fault significantly depletes the available pack power. In order to achieve the necessary safety and driving range for battery packs in transportation applications, it is desired to provide the energy density of a lithium ion or lithium polymer battery pack with the safety of older battery chemistries. Thus, there is a need in the battery protection field to create an improved power source and method of managing a power source.

### BRIEF DESCRIPTION OF THE FIGURES

FIG. 1 is an abstract representation of a first preferred embodiment of the invention.

FIG. 2 is a detailed schematic representation of the battery modules of FIG. 1.

FIG. 3 is a detailed schematic representation of the battery protection circuit of FIG. 2.

FIG. 4 is a detailed schematic representation of the pack-unit of FIG. 1.

FIG. 5 is a detailed schematic representation of the integration level of FIG. 1.

FIG. 6 is a detailed schematic representation of the integration level of FIG. 1, similar to FIG. 5, showing the isolation of a pack-unit by the activation of the electrical bridge bypass.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

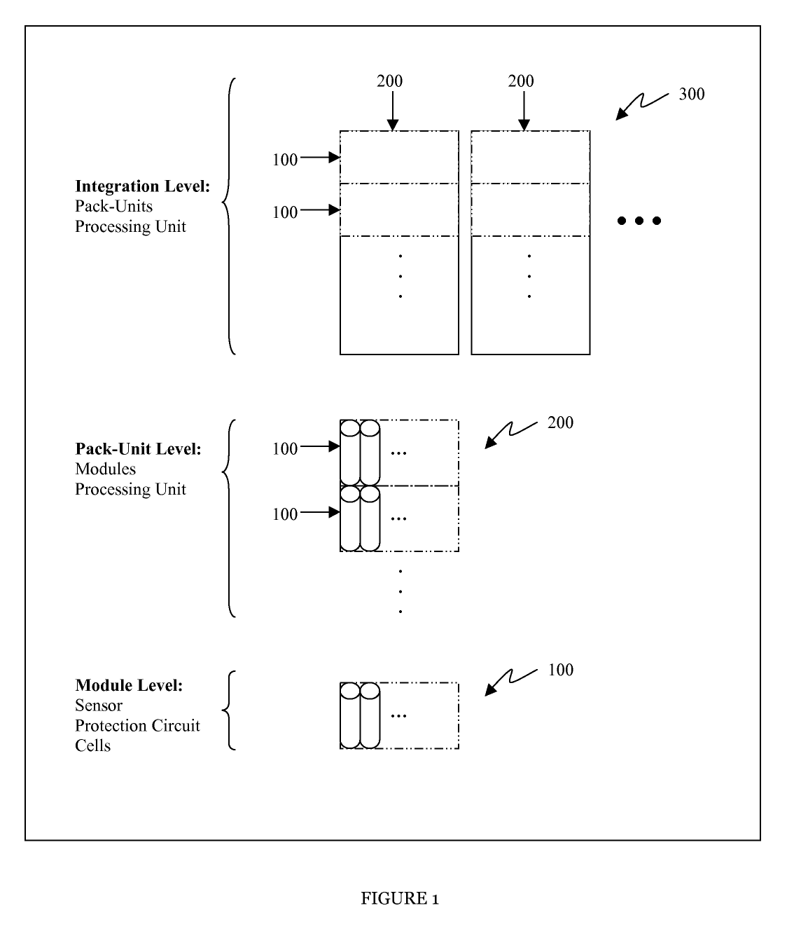

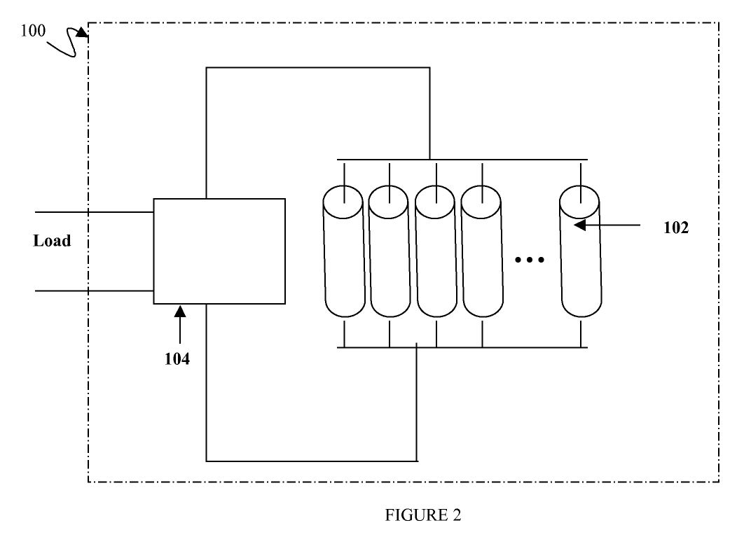

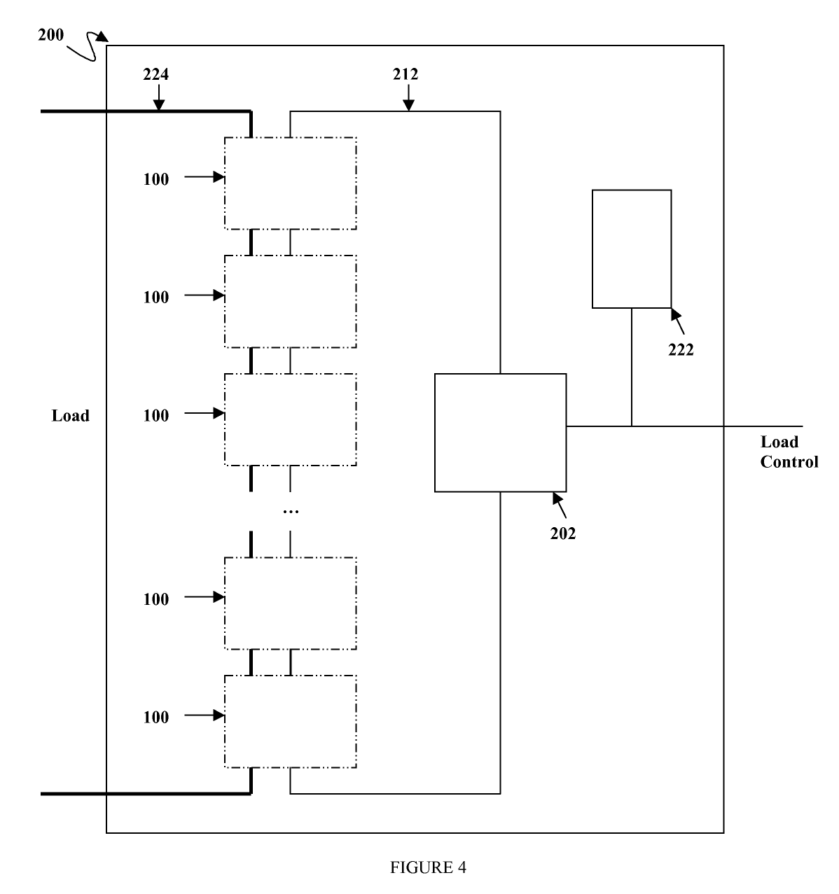

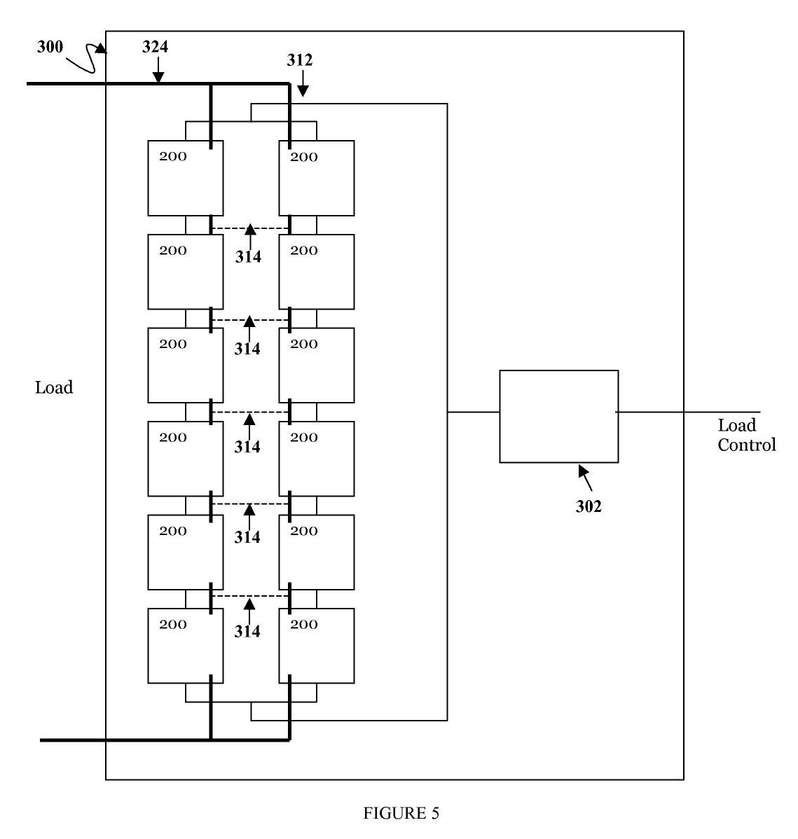

In the abstract, as shown in FIG. 1, the power source of the preferred embodiment includes a module level, a pack-unit level, and an integration level. On the module level, as shown in FIG. 2, the modules 100 of the preferred embodiment include a plurality of cells 102, a sensor 110, and a battery protection circuit 104. On the pack-unit level, as shown in FIG. 4, the pack-unit 200 of the preferred embodiment for protecting battery packs includes a plurality of battery modules 100, a processing unit 202, and a data bus 212. On the integration level, as shown in FIG. 5, the system 300 of the preferred embodiment includes a plurality of pack-units 200, a central processing unit 302, and a data bus 312. The invention provides a system for scalable, fine grain protection of battery packs, which may provide additional safety, reliability, and maintenance features that increase the range and usable life of the battery pack. The multi-level management facilitates the intelligent application of methods for continuous optimization of the performance and safety of the cells 102. Such packs are likely to be used in transportation applications, although they may also find use in other fields such as outdoor power equipment, uninterruptible power supplies, and auxiliary power units.

### 1. Module Level

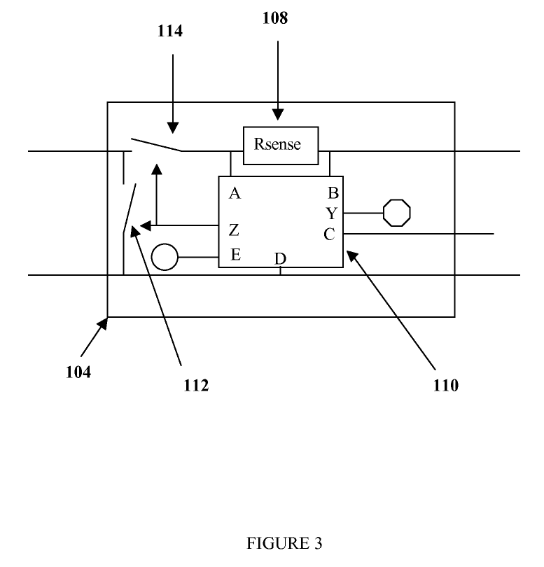

As shown in FIGS. 2 and 3, the battery modules 100 include at least one cell 102, a sensor 110 to measure parameters of the cell (such as voltage, current, temperature, failure modes, physical location, air/gas pressure, or any other suitable parameter), and a battery protection circuit 104 to disconnect the battery module from the pack-unit. The battery module 100 preferably contains at least one battery protection circuit 104 for each cell 102, but may alternatively contain one battery protection circuit 104 for a plurality of cells 102. The battery module 100 may also preferably includes circuitry to control temperature regulation fluid flow through the module and circuitry to communicate with neighboring modules to obtain information on operating conditions of neighboring modules. Neighboring modules are defined as those modules that are in physical and/or electrical proximity to the current module.

The cells 102 of the preferred embodiment function to store energy. Preferably, each cell 102 is a conventional battery designed for use in small-scale applications like mobile phones and laptop computers. In a first version, the cells 102 are a lithium ion cell of type number 18650, which have the following specification: Nominal Voltage is 3.6-3.7 V, Shape is cylindrical, Diameter is 18 mm, Length is 65 mm, and Capacity is 2400-2600 mAh. These cells, which are lightweight and have a high energy density, are generally used in laptop computers. In a second version, the cells 102 are a lithium ion cell of type number 26700 (which have the following specifications: Shape is cylindrical, and Diameter is 26 mm, Length is 70 mm). With minimal or no modifications, the cells may be of greater (or lower) capacity and/or of greater (or lower) voltage. The cells 102, in fact, may be of any suitable composition, of any suitable shape, and of any suitable performance specification. The battery module 100 preferably contains 1-7 cells 102. The cells 102 of the battery module 100 are preferably arranged in a parallel electrical structure, but may alternatively be any other electrical structure suitable to provide adequate voltage levels to the device.

As shown in FIG. 3, the sensor 110 of the preferred embodiment functions to measure the operating conditions of the cells in the module. The operating conditions preferably include current, voltage, and temperature, but may additionally include pressure and another other suitable parameters. The sensor 110 preferably includes a current sensor, a temperature sensor, a voltage sensor, and a pressure sensor. The current sensor preferably measures current through Rsense 108 (using nodes A-B). Rsense 108 is preferably a resistance or impedance used to measure current. Rsense 108 may alternatively be a hall-effect sensor or any other sensor suitable to measure current. The voltage sensor preferably measures voltage across the cell 102 (using nodes B-D). The temperature sensor preferably measures the temperature of the cell 102 using node C. The pressure sensor preferably measures the air pressure of a confined space enclosing the cell 102 using node E. The current sensor, temperature sensor, voltage sensor, and pressure sensor may, however, be of any suitable device and method to measure their respective parameters.

As shown in FIG. 2, the battery protection circuit 104 functions to disconnect individual cells 102 or a plurality of cells 102 if a fault condition is detected. A fault condition may be indicated if the parameter rises above a particular threshold (such as “over voltage”, “over current”, or “over temperature”), drops below a particular threshold (such as “under voltage” or “under temperature”), or changes more than a particular amount over a particular time period (such as “increased air pressured”). The battery protection circuit 104 may alternatively monitor for fault conditions in the cell 102 based on other suitable fault conditions for a cell 102 or a plurality of cells 102, such as the internal characteristic resistance of a cell, which may change over time. This resistance and its change over time may indicate the remaining life of the cell 102. One or more cells 102 are preferably electrically disconnected by controlling a bypass disable/enable switch 112 and a connection/disconnection switch 114 of the cell 102. This allows individual cells 102 or a plurality of cells 102 to be switched out on a fault condition; these may also be switched back in if the fault condition does not persist, for example, if a hot cell 102 or plurality of cells 102 returns to operable temperatures when switched out, it may be switched back in at a lower temperature threshold. As the cells 102 are switched out entirely on an over-voltage condition, there is little additional power consumed. The battery protection circuit may, however, electrically disconnect one or more cells by other suitable methods, such as re-directing the current flow through a grounding connection.

The battery protection circuits 104 are preferably conventional battery protection circuits. Preferably, the fault conditions in the battery protection circuits 104 have at least one threshold for cell operating conditions. The thresholds are preferably programmed into the module, but may alternatively be defined by hardware in the module. The programmed threshold may also be adjusted during the operation of the module. The thresholds may also exist in more than one layer. For example, a software threshold either at the pack-unit level or the integration level may be used concurrently with a hardware threshold in the module level. With multiple threshold, the software threshold may be a lower value such that the hardware threshold acts as a backup threshold. In other words, the hardware threshold functions to define the fault conditions when the software malfunctions or is not available. The programmed threshold, at the pack-unit level and/or integration level, is preferably adjustable during the operation of the module. The battery protection circuit 104 preferably communicates battery module parameters, such as voltage, current, temperature, and pressure, to at least one processing unit 202, across a serial data bus 212. Additionally, the battery protection circuit 104 preferably identifies and communicates its physical, thermal, and electrical proximity to other battery protection circuits 104. This proximity identification preferably uses a number or set of numbers to indicate location within the larger battery pack and physical, thermal, and electrical proximity to neighboring cells and battery protection circuits 104. This identification, which is preferably unique to each battery protection circuit 104, preferably divides the pack into proximate zones. The battery protection circuit 104 also preferably receives physical, thermal, and electrical conditions from neighboring protection circuits 104 of neighboring modules. This information preferably facilitates the battery protection circuit 104 in determining safe to operate conditions based upon the performance of neighboring modules.

As shown in FIG. 3, in the battery protection circuits 104 of the preferred embodiment, the output from node Z preferably controls the switches for cell connection/disconnection 114 and bypass disable/enable 112. Preferably, the switches for cell connection/disconnection 114 and bypass disable/enable 112 are programmable transistor based switches. A field effect transistor (FET) is preferably used for cell connection/disconnection 114 and is preferably controlled by the battery protection circuit 104. Cell connection/disconnection 114 may alternatively be an insulated-gate bipolar transistor (IGBT), a mechanical contractor, or any other suitable switching device. The field effect transistor is employed in series with the battery terminals to switch the cell 102 in or out of the circuit: a bypass path 112 is provided to permit current flow when the cell is switched out. The battery protection circuit 104 preferably also includes circuitry to detect catastrophic failure of cells 102 and immediately disconnect to prevent spread of catastrophic failure to neighboring battery modules 100. Catastrophic failure may be detected by sudden increases in pressure within the battery module 100. In addition, the battery protection circuit 104 may communicate with an external temperature-regulating system, such as a fluidic network. The battery protection circuit 104 may include an output Y that controls switches for valves that allow temperature-regulating fluid through the module. The switch may be a two state on/off switch or a variable switch such as a potentiometer.

### 2. Pack-Unit Level

As shown in FIG. 4, the pack-unit 200 of the preferred embodiment for protecting battery packs includes at least one battery module 100, a processing unit 202, a data bus 212, and a load power delivery path 224. Each battery module 100 preferably contains 10% or less of the overall cells in the battery pack-unit 200.

The battery modules 100 are preferably arranged in series within the battery pack-unit 200. This provides a high voltage level to the device that is relatively minimally affected by the disconnection of battery modules 100 from the battery pack-unit 200. However, the battery modules 100 may also be arranged in any other electrical arrangement suitable to powering the device.

The processing unit 202 functions to store parameter data in memory, correlate parameters to failure, and manage module connection states. The processing unit 202 also preferably functions to manage temperature regulation of the modules within pack-unit 200. The processing unit 202 preferably includes a processor and a memory unit, and communication circuitry to connect to an external interface 222 (via a suitable connection such as RS-232, USB, or IEEE-1394) as well as the internal data bus 212.

The data bus 212 functions to transmit parameter measurements from the battery modules 100 to the processing unit 202, and preferably also functions to carry module connection management data from the processing unit 202 to the battery modules 100. The data bus 212 is preferably a serial data bus connecting the battery modules 100 and the processing unit 202. The data bus 212 preferably allows data and control signals to flow from the battery modules 100 to the processing unit 202 as well as from the processing unit 202 back to the battery modules 100. The processing unit 202 preferably transmits commands over the data bus 212 to the battery modules 100, switching the battery modules 100 in or out of the pack controlled by the processing unit 202. Preferably, the signals from the processing unit 202 will take a higher priority than any internal control circuitry in the battery modules 100, allowing the processing unit 202 to override the internal circuitry of the battery modules.

The processing unit 202 also preferably evaluates real time operation data from a plurality of battery modules 100 and determines optimal pack-unit operation. For example, temperature readings from a certain location within the battery pack-unit 200 may be higher than those from another location. To compensate for this, the processing unit 202 may send control signals through data bus 212 to preferably minimize power draw from the high temperature region until temperature throughout battery pack-unit 200 normalizes. To maintain power output of the pack-unit 200 when the output of one or more of the battery modules 100 is limited, the power output from other normally operating battery modules 100 in the pack-unit 200 may be increased. Location of the battery module 100 within the pack-unit 200 may be used to determine the re-balancing of power output. Alternatively, the processing unit 202 may communicate with an external temperature regulating system through battery protection units 104 and send control signals through data bus 212 to change the state of the temperature regulation through the high temperature region. However, the processing unit 202 may also communicate directly with an external temperature regulating system to regulate temperature in a high temperature region. Additionally, the processing unit 202 preferably evaluates real time operation data with historical data from the battery modules 100. This facilitates the prediction of abnormal battery module 100 behavior based upon historical performance data of each particular module and the location of the battery module 100 within battery pack-unit 200. For example, operational temperatures from battery modules 100 located in a certain location of battery pack-unit 200 may be consistently higher than those in other locations. Processing unit 202 may detect this pattern and signal for maintenance. Additionally, the processing unit 202 may detect the tendency for certain battery modules 200 to operate under normal conditions at higher temperatures. In response to this pattern, the processing unit 202 may increase the pre-programmed temperature fault threshold for these particular battery modules 100. This dynamic adjustment of the programmed thresholds allows the pack-unit 200 to adapt to manufacturing and operation variations in the battery cells 102. The processing unit 202 may also detect operating conditions that are similar to those seen prior to catastrophic failure and may disconnect those battery modules 100 in danger of failure, preventing catastrophic failure from affecting the battery pack-unit 200. Additionally, the processing unit 202 may detect battery modules 100 whose operating conditions do not improve with re-balancing of power output or any other failure prevention adjustments and may disconnect these battery modules 100 from the pack-unit 200 to prevent failure. The processing unit 202 may also be pre-programmed to expect certain patterns in the performance of a battery module 100. The historical data stored in processing unit 202 is preferably available for diagnostics during maintenance of the battery pack-unit 200.

The processing unit 202 also preferably evaluates real time operation data from the neighbors of each battery module 100. In the case of a non-operational battery module 100, the processing unit 202 preferably evaluates the real time operation data from all neighboring battery modules 100 to determine whether the neighboring battery modules 100 exhibit failure characteristics. “Neighboring battery modules” 100 preferably means directly adjacent, but my additionally include battery modules within a particular distance, along a particular electrical connection, or any other suitable parameter. In the case of an operational battery module 100, the processing unit 202 preferably evaluates the real time operation data from all neighboring battery modules 100 to determine whether the neighboring battery modules exhibit characteristics that may harm the current battery module 100, for example, increased pressure and/or high temperature. Additionally, the processing unit 202 preferably evaluates real time operation data with historical data from the neighboring battery modules 100. This facilitates the prediction of adverse effects between neighboring battery modules 100. For example, the processing unit 202 may notice that certain trends in operation data (high rate of temperature increase, consistently low levels of power output, etc.) have a stronger effect on neighboring battery modules 100. Examining historical operation data of neighboring battery modules 100 may also facilitate distinguishing battery modules 100 that may have better performance if grouped together.

The processing unit 202 also preferably controls current and power output of the battery pack-unit 200 based upon operating conditions measured within the battery pack-unit 200 and the power requirements of the device powered by the power source. For example, if all battery modules 100 are in healthy condition, the processing unit 202 preferably allows maximum current and power output. However, if one, some, or all of the battery modules are under non-optimal operating conditions, the processing unit 202 preferably limits current and power output.

In a preferred embodiment, the pack-unit 200 further includes an external interface 222. The external interface 222 functions to communicate (through either a display and/or a data port) the cell performance data from the processing unit 202. The external interface 222 is preferably connected to the processing unit 202 via IEEE 1394, but may be connected to the processing unit 202 via RS-232, IEEE 1284, Ethernet, Wireless, Bluetooth, USB, or any other suitable communication protocol.

### 3. Integration Level

As shown in FIG. 5, the system 300 of the preferred embodiment includes a plurality of pack-units 200, a central processing unit (“CPU”) 302, a data bus 312, a load power delivery path 324, and electrical bridge bypasses 314.

The pack-units 200 in the system 300 of the preferred embodiment are preferably arranged in a combination parallel and series electrical structure. The pack-units 200 are preferably split into two in-series electrical structures, each preferably with the same number of pack-units 200. These two series electrical structures are then arranged in parallel and an electrical bridge bypass 314 is included in between each neighboring parallel battery pack, as shown in FIG. 5, to allow for various electrical arrangements. Alternatively, the pack-units may be arranged in a “main pack” and “auxiliary pack” configuration such that only the “main pack” is in constant use by the device and the “auxiliary pack” is put into use when the “main pack” experiences an operation malfunction. However, the pack-units 200 may be arranged into any other electrical structure suitable to powering the device. As mentioned previously, each pack-unit 200 is preferably capable of communicating with the CPU 302 through data bus 312. The pack-units 200 are preferably connected directly to the processing unit 200 where the state of connectivity may be controlled by the processing unit 200. Alternatively, the pack-units 200 may also be directly electrically connected with each other and preferably function to control individual state of connectivity.

The CPU 302 preferably functions to control current and power output from the system 300 based upon device power requirements and the state of the system 300. The CPU 302 also preferably functions to communicate with pack-units 200 through data bus 312. Data representative of the status of modules 100 within pack unit 200 are preferably communicated to the CPU 302. Preferably, data representative of the voltage, current, temperature, and/or pressure of the modules 100 within pack-unit 200 are communicated to the CPU 302. Alternatively, data representing the overall state of pack-unit 200 may be communicated to the CPU 302. For example, data representing the number of modules 100 that are in operation in pack-unit 200, the equivalent current and power output of pack-unit 200, the overall temperature of pack-unit 200, and/or the overall pressure of pack-unit 200, may be communicated to the CPU 302. The data communicated to the CPU 302 from each of the pack-units 200 are preferably compared to pre-programmed operable thresholds for each set of data to determine overall health of the pack-unit 200. For example, one such threshold may indicate the maximum number of inoperable modules that can be within any one pack-unit at one time; another such threshold may indicate the maximum length of time for which a battery parameter such as voltage, current, or temperature may be at a certain level, indicating the inability of the pack-unit 200 to restore safe operating conditions for the cells 102 contained within, or yet another such threshold may indicate a maximum overall pressure within pack-unit 200. Other indicators of pack-unit 200 or battery module 100 health may be changes in the frequency of occurrences in which a battery parameter such as voltage, current, or temperature may be at a certain level, indicating potential failure. The lack of improvement of operation conditions despite modulation of operational parameters of pack-unit 200 or battery module 100 may also indicate potential failure. These thresholds are preferably adjusted during the operation of the system to adapt to variations in the performance of a pack-unit 200.

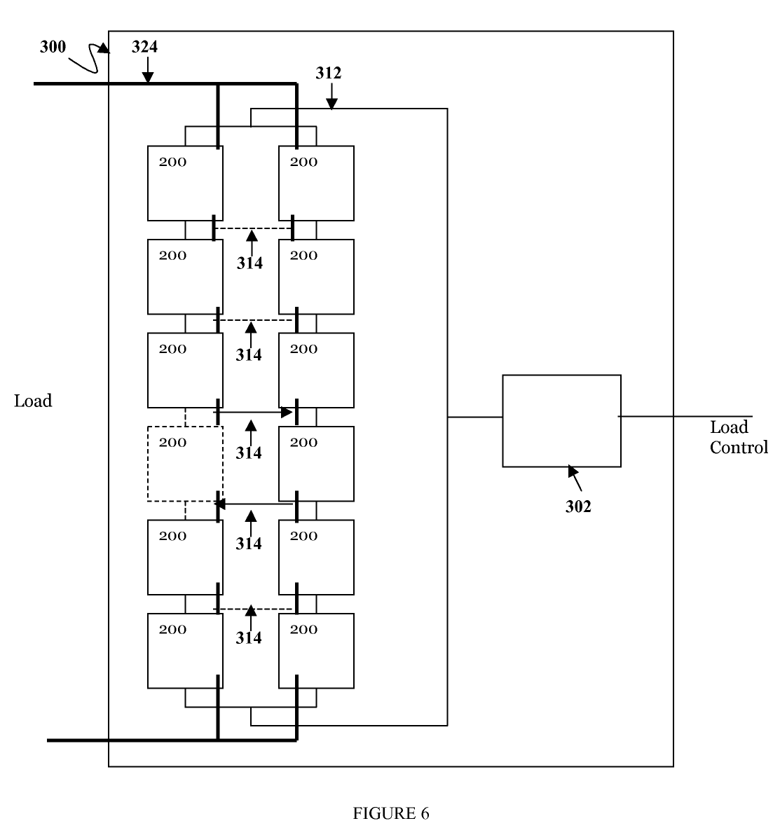

The CPU 302 preferably sends signals to each pack-unit 200 through the data bus 312 to retrieve operation data and to analyze pack-unit 200 to determine whether to disconnect or reconnect pack-unit 200 from/to the system 300, or to adjust power output of the pack-unit 200. Alternatively, each pack-unit 200 in the system 300 may also be capable of detecting internal operating conditions and disconnecting and connecting itself to the system 300. In the event the CPU 302 detects a pack-unit 200 that is operating at conditions that are deemed unhealthy by the CPU 302, the CPU 302 preferably electrically isolates said pack-unit 200 from the system 300. With the combination parallel and series electrical structure of the battery packs described above, in the event the CPU 302 determines a pack-unit 200 is inoperable, the pack-unit 200 may be isolated by the activation of the electrical bridge bypass 314 to reroute power in the system, as shown in FIG. 6. In this case, one pack-unit 200 in the system 300 will experience twice the load of other operating pack-units 200 in the system and the total current of the system 300 is preferably limited to minimize wear on the double-loaded pack-unit 200. Alternatively, in the “main pack” and “auxiliary pack” battery pack integration structure variation described above, in the event an inoperable pack-unit 200 is detected, the CPU 302 may isolate all battery packs that may be in use and switch to the “auxiliary pack.”

The data bus 312 of the preferred embodiment functions to transmit operation data from the pack-units 200 to the CPU 302, and preferably also functions to carry pack-unit 200 connection management data from the CPU 302 to the pack-units 200. The data bus 312 is preferably a serial data bus connecting the pack-units 200 and the CPU 302. The data bus 312 preferably allows data and control signals to flow from the pack-units 200 to the CPU 302 as well as from the CPU 302 back to the pack-units 200. The pack-units 200 preferably transmit data over representing the connection state of each individual pack-unit 200 over data bus 312. Alternatively, the CPU 302 may also transmit commands over the data bus 312 to the pack-units 200 to switch the pack-units 200 in or out of the system 300. Preferably, the signals from the CPU 302 will take a higher priority than any internal control circuitry in the pack-units 200 or the battery modules 100, allowing the CPU 302 to override the internal circuitry of the pack-units 200 or the battery modules 100.

As a person skilled in the art will recognize from the previous detailed description and from the figures and claims, modifications and changes can be made to the preferred embodiments of the invention without departing from the scope of this invention defined in the following claims.

We claim:

1. A power source, comprising:
a plurality of battery groups, each group including a plurality of cells, a sensor subsystem adapted to sense operating parameters of the cells, and a protection circuit coupled to the sensor and adapted to electrically disconnect the group from the power source; and
a processor coupled to the groups and adapted to electrically disconnect a group from the power source.

2. The power source of claim 1, wherein the plurality of cells includes separate units of individually functional cells.

3. The power source of claim 2, wherein the plurality of cells includes one of the following: lithium ion cells of type number 18650 and lithium ion cells of type number 26700.

4. The power source of claim 1, wherein each sensor subsystem includes a voltage sensor, a current sensor, and a temperature sensor.

5. The power source of claim 4, wherein each sensor subsystem further includes a pressure sensor.

6. The power source of claim 1, wherein the protection circuit is adapted to electrically disconnect groups from the power source based upon a comparison of data from the sensors to a threshold.

7. The power source of claim 6, wherein the protection circuit is further adapted to electrically reconnect groups to the power source.

8. The power source of claim 1, wherein the protection circuit includes a processing unit.

9. The power source of claim 1, wherein the processor is adapted to electrically disconnect a group from the power source based upon a comparison of data from the sensor of the group to a threshold.

10. The power source of claim 9, wherein the processor is further adapted to electrically reconnect a group to the power source.

11. The power source of claim 9, wherein the processor is further adapted to electrically disconnect a group from the power source based upon historical data from the sensor of the group.

12. The power source of claim 9, wherein the processor is further adapted to electrically disconnect a group from the power source based upon data from a sensor from another groups in relative proximity.

13. The power source of claim 1, further comprising a data bus coupled to the processor and adapted to transmit data from the sensors of the battery groups.

14. A system comprising: a plurality of power sources, each as defined in claim 1; and a central processing unit coupled to the processors of the power sources and adapted to electrically disconnect a power source from the system.

15. The system of claim 14, further comprising electrical connections amongst the plurality of power sources that cooperate to connect the plurality of power sources in a combination parallel-series electrical arrangement.

16. The system of claim 15, further comprising bypass electrical connections adapted to allow electrical bypass of a disconnected power source.

17. A method of managing a power source with a two-tier approach, the method comprising the steps of:
electrically grouping a plurality of cells into groups;
on a group level—retrieving cell data representative of the operating parameters of the cells of the group and managing the connection state of the group on a group level based on the retrieved cell data; and
on a system level—retrieving group data representative of the operating parameters of the groups and managing the connection state of the group on a system level based on the retrieved group data.

18. The method of claim 17, wherein managing the state of the group on a group level includes electrically disconnecting the group from the power source based upon a comparison of the cell data from the group to a threshold.

19. The method of claim 18, wherein the threshold is a pre-determined threshold.

20. The method of claim 17, wherein managing the state of the group on a system level includes electrically disconnecting the group from the power source based upon a comparison of the cell data from the group to a threshold.

21. The method of claim 20, wherein the threshold is a dynamic threshold.

22. The method of claim 20, wherein managing the state of the group on a system level includes electrically disconnecting the group from the power source based upon historical data from the sensors of the group.

23. The method of claim 20, wherein managing the state of the group on a system level includes electrically disconnecting the group from the power source based upon data from other groups in relative proximity.

24. The method of claim 17, wherein managing the state of groups on a system level further includes adjusting operation parameters of a group to modulate the operating parameters of the group.

25. The method of claim 22, wherein adjusting operational parameters of a group includes adjusting power output of the group and adjusting current output of the group.

26. The method of claim 22, wherein adjusting operational parameters of a group further comprises at least one of the following steps:
decreasing power output of one group while increasing power output of another group; and
decreasing current output of one group while increasing current output of another group.
